(19) United States
(12) Patent Application Publication
(10) Pub. No.: US 2004/0203750 A1
(43) Pub. Date: Oct. 14, 2004

(54) Transport of records of roaming usage of mobile telecommunications networks

(76) Inventors: Lee Cowdrey, Harlow (GB); Philip William Hobson, Hertfordshire (GB); Michael Waddell, Harlow (GB)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/272,170

(22) Filed: Oct. 16, 2002

(51) Int. Cl. H04M 1/66; H04M 1/68; H04M 3/16; H04Q 7/20

(52) U.S. Cl. 455/432.1; 455/411

(57) ABSTRACT

A system for a visited mobile telecommunications network, for sending information relating to roaming use back to a home network of the roaming user, sends telco records in near real time over a direct, P2P route, over the internet, not via a central clearing house. By sending the information more quickly, fraud detection at the home network can be improved. As this decentralized arrangement involves lower costs to the visited network, it is more likely to be installed by operators in higher risk areas, so benefits of wider coverage (“critical mass”) can be achieved. A central WebManager manages the P2P network and maintains a record of operators to verify the information sent between nodes of the P2P network, is from a recorded operator.

### FIELD

This disclosed methods and systems relate to systems for transporting of records of roaming usage of cellular telecommunications networks, to administering a peer-to-peer (P2P) network for such transport, to corresponding methods and software, to fraud detection using such records, and to roaming use which is protected by such fraud detection.

### BACKGROUND

A report in Internet World M-Commerce World, “International Bureau Fighting Telecom Fraud”—Feb. 7, 2002, indicated that telecommunications carrier organizations are beginning to recognize the seriousness of the fraud problem. Telecom fraud has been difficult to measure internationally because there is no requirement to report fraud to one central organization. One prediction indicates wireless fraud could cost the industry more than $677 million in 2002, with subscription fraud losses making up around 70 percent.

The same report indicated that amongst the 100 or so telecommunications operators in Europe, projected GSM roaming fraud loss is estimated at 0.3 percent of the revenue of a carrier. According to British Telecom, a recent revenue assurance survey estimates revenue “leakage” to be approximately 12 percent, with about 3.2 percent attributed directly to fraud. Of the various types of telecom fraud, fraudulent roaming activity is by far the biggest financial burden on telecom carriers as international roaming fraud opportunities rise. The ability to support freely roaming traffic is a financial and customer service imperative to both home and roaming or “serving” carriers.

Roaming involves a subscriber of one operator, (“home” operator) using the network of foreign operator. The foreign operator will have an agreement with the “home” operator to allow the “home” operator's subscriber to use services within the foreign operators area of operation. The foreign operator will generally send each usage record such as call detail records (CDRs) produced by the visiting subscriber back to the “home” operator for billing and settlement purposes. An example of transporting and translating such CDRs between mobile networks is shown in U.S. Pat. No. 5,873,030 Mechling et al. “Method and system for nationwide mobile telecommunications billing”. In this case the CDRs are transported in the usual time frame for a billing cycle, e.g. 24 hours. Roaming fraud occurs when the call was not made with the consent of the subscriber. There are various ways this can occur, including physical theft of the phone, or the SIM card, or by simulating the identifying codes normally transmitted by the phone (also known as cloning).

Roaming fraud is the one type of fraud that has not been dealt with effectively due to the time delays between the time the calls were made and the time the “home” operator received the CDRs that then could be inspected for fraud. Different approaches have been applied with varying degrees of success.

A formal prevention currently widely accepted is the High Usage and Suspected Fraud Fax sent after a pre-determined threshold is reached (usually 100 SDR, (Standard Drawing Rights—which is a notional, standardised and universal currency used by telecommunications service providers to value inter-administration [inter-operator] calls, currently valued at around 1SDR =$1US). These however often arrive at empty offices during weekends and only get the necessary attention hours later. During the GSM MoU Association Fraud Forum meeting in 2000 in Orlando Fla., Mobile Operators agreed to send these reports by e-mail as well.

In principle, fraud detection and prevention can take place during call set up and validation, or later using information or records gathered after call set up. An attempt to do the former is described in U.S. patent application No. 20020086671A1, UMESH J. AMIN, et al. Jul. 4, 2002 “ROAMING AUTHORIZATION SYSTEM”. However, the problem of non fraudulent calls being delayed or blocked makes it difficult to make such arrangements effective, with such a short time to make a call authorization decision. Also, such arrangements depend on the provisions of mobile technical standards such as GSM, and cannot easily accommodate multiple different mobile standards. Accordingly, attention has focused on using records such as call data records gathered after call set up, for billing and network management purposes. Availability of near real-time call detail records of roaming users can assist a wireless telecom company to mitigate fraud.

Without special measures to improve visibility of CDRs, there can be a 24-to-72 hour or longer delay in receiving roaming records from the serving carrier. Delayed record exchanges create an opportunity for roaming fraud. Detection time can be reduced from days to minutes. Roaming fraud can be detected before large losses accumulate. In addition, inter-carrier fraud (called “splashing”) can be prevented. Counterfeited or stolen SIM cards also are more rapidly detected, so repeat bad debt is reduced.

To achieve such near real time visibility, it is known to use an international roaming record exchange system (which sends call detail records from the service carrier to the home carrier in near real time). The home operator can then use its own fraud detection software to make a decision and prevent further use of the phone in near real time.

One example is the Roamex™ product advertised by HNC software inc. Another is the DataNet™ product advertised by TSI Telecommunications services inc. However, such record exchange systems have a number of drawbacks. They rely heavily on having comprehensive coverage of virtually all wireless carriers worldwide, particularly those in parts of the world with higher levels of fraud, which is unlikely to happen.

Roamex is a very expensive solution. In 1999 the average operators paid approx. USD 0.50 per customer (for all customers, the non-roaming customers as well) as fee per annum. It is therefore not or hardly interesting for the EMEA market, according the GSM MoU meeting end 1999.

Prior to that, Vodafone had already investigated a more cost effective solution and came up with FIGS, the Fraud Information Gathering System. It requires CAMEL, the GSM version of IN (Intelligent Network) that enables a subscriber to inherit home network features whilst roaming. The problem with this is that CAMEL will not be implemented everywhere, and FIGS is not operational yet and will probably never be with a portion of the networks.

One difficulty with implementing a roaming fraud countermeasure, including a fast CDR exchange system is the fact that problems occur at the roaming partner where the home network has no control and is dependent on the “cooperation” of the roaming partner to report problems. The costs of the visited network will generally always be paid by the home network. This is a particular problem where the roaming fraud is not reciprocal, that is it does not occur evenly in different operators' networks. For example, often operators from advanced countries experience problems with roaming fraud from less developed countries, whereas the operators in the less developed countries have little “reciprocal” revenue loss from roaming fraud in those more advanced countries. Thus the roaming partner operators in the less developed countries have little incentive to invest in expensive fraud countermeasures.

### SUMMARY

The disclosed methods and systems include a first mobile telecommunications network, for sending information relating to use of the first network by a roaming user from one of many other mobile telecommunications networks,

the system being arranged to:

identify which of the other networks is a home network of the roaming user, and

send the information to an operator of the home network, in near real time over a direct, P2P route, not via a central clearing house.

This decentralized arrangement can reduce capital costs and running costs as there is no need for the costly infrastructure of a third party central exchange, as well as faster transfer speed. Near-real-time transfer, such as a 60 sec cycle is feasible, since there is no delay by an intervening central exchange. This means the cost to the visited network can be kept low, thus making it more likely to be installed by operators in higher risk areas, so the benefits of wider coverage (“critical mass”) can be achieved. Also, privacy can be enhanced, since there is no need to rely on a third party who controls the central clearing house. Also, the total volume of communications can be halved, potentially, if it is sent directly to its destination rather than in two hops, via a central clearing house. Notably, this solution can be easy for operators to install, and easy to extend to cover future networks such as 3G networks, as they begin to come into service, as well as covering inter standard roaming. The roaming usage can of course encompass voice calls, SMS messaging, email or other internet access, and video streaming over the internet, as well as other types of telecom usage of wireless handsets. The usage information can include amount or value of the use, for billing or other purposes, or the location of usage, for location based services, for example.

A computer can be both client and server making it highly portable. It supports e-commerce needs (by using public protocols and methods but ensuring data that is exchanged is secure from un-authorised 3rd parties ). The P2P principle means that the information is not sent through diverse sub systems to facilitate delivery (like email), but is sent from source to destination directly bypassing sub systems (like FTP). It can be designed to support the sharing and distribution of data.

As an additional feature, the system is arranged to route the information over the public internet.

This can reduce running costs, since leased circuits can be avoided. This can enable a charging structure which is fixed and pre-determined regardless of volumes and number of partner operators. This may be much preferred to the unpredictable, indeterminate, and variable costs dependent upon subscriber activity, implied by using leased lines. Also, there is usually an existing corporate Inter/Intranet connection at an operator, which can be used, so avoiding some of the infrastructure costs.

As an additional feature, the system is arranged to route the information in a secure, encrypted form. This can ensure privacy of the information, which can be sensitive. It can be achieved using open and public protocols, to reduce commercial risks of using a proprietary closed protocol which might become expensive to maintain or administer in the future. The transport mechanism can include either public or proprietary encryption and industry standard compression (such as Zip compression/decompression), ensuring highly licensable interface.

As an additional feature, the system is arranged to receive information from other operators, relating to roaming by a user whose home network is the first network, the information being routed over a direct, P2P route, not via a central clearing house.

Clearly, the same applies to flows of information in both directions. The P2P routes can form a logical network for these flows between some or all of the operators.

As an additional feature, the system is arranged to cooperate with a central manager, called a WebManager, for verifying the validity of a sender of the information received, the central WebManager having a record of operators who have agreed to be roaming partners.

In principle, such a WebManager could be centralized or decentralized and carried out at the operators. Although the decentralized possibility is encompassed by the broader claims, in practice, it is more convenient to maintain a record of operators centrally so as to reduce the duplication of effort when there are hundreds of operators, and to reduce the computation load and technical expertise needed at an operator.

As an additional feature, the system is arranged such that operators can remotely update the record of operators who have agreed to be roaming partners.

As an additional feature, the system is arranged to feed the received information to a fraud detection system. This is one principal application for the information, though other uses are conceivable, such as TAP (Telephony Accounting Protocol) File reconciliation by using a correlator to compare TAP files with Roaming telco record files, and identification of market trends for roamers.

As an additional feature, the received information comprises one or more call detail records. This is currently a widely used and easily available format for the information, but in principle, another format or type of information could be used, provided it has some information about the roaming usage, suitable for assisting in deciding whether the usage is fraudulent.

A second aspect provides a system for a first mobile telecommunications network, for sending information relating to use of the first network by a roaming user from one of many other mobile telecommunications networks, the system being arranged to: identify which of the other networks is a home network of the roaming user, and send the information to an operator of the home network, in near real time over the public internet.

As an additional feature, the system is arranged to route the information in a secure, encrypted form, in a point-to-point manner.

As an additional feature, the system is arranged to receive information from other operators, relating to roaming by a user whose home network is the first network, the information being routed over the public internet.

As an additional feature, the system is arranged to use the received information for fraud detection.

A third aspect provides a method of detecting roaming fraud for use by an operator of a first mobile telecommunications network, when subscribers of the first network conduct roaming usage of one of many other mobile telecommunications networks, the method comprising: receiving information from another of the operators, relating to the roaming usage, the information being routed over a direct, P2P route, not via a central clearing house, in near real time, and using the received information to detect fraudulent usage.

A fourth aspect provides a method of roaming usage by a subscriber of a first mobile telecommunications network, the network having a fraud detection system, the method comprising:

conducting roaming usage when visiting one of many other telecommunications networks,

causing the visited network to send information relating to the roaming usage, to the first network, for use by the fraud detection system, the information being routed over a direct, P2P route, not via a central clearing house, in near real time, and

receiving a bill from the operator of the first network which has been checked for fraudulent usage, and including an amount for the roaming usage.

A fifth aspect provides a central WebManager for use with a P2P network used for sending information relating to roaming usage between network operators, the WebManager having:

a record of operators who are in the P2P network, and

an arrangement for communicating with nodes of the network, to verify the information sent between nodes of the P2P network, is from a recorded operator, using the record.

As an additional feature, the WebManager is arranged to provide central management of the P2P network.

A sixth aspect provides a method of offering a central validation service for a P2P network used for sending information relating to roaming usage between network operators, the method comprising:

maintaining a record of operators who are in the P2P network, and

communicating with nodes of the network, to verify information sent between nodes of the P2P network, using the record.

As an additional feature, the system is in the form of software. This acknowledges that such software can be a valuable, separately tradable commodity.

Another aspect provides a method of offering a data transmission service over a network having such a system (such as for 2.5G/3G services like GRPS, WAP, EMS/MMS {Picture Messaging}). The disclosed methods and systems can enable a network with increased reliability and flexibility, and/or capacity, and/or more cost effective for example, consequently a data transmission service over the network can show a corresponding improvement, and the value of such services can increase.

Any of the features can be combined with other aspects as would be apparent to those skilled in the art. Other objects and advantages will be apparent to those skilled in the art.

### BRIEF DESCRIPTION OF THE DRAWINGS

To show by way of example, embodiments will now be described with reference to the figures in which:

FIG. 1 shows an overview in schematic form of a P2P network linking mobile networks according to an embodiment;

FIG. 2 shows in schematic form principal elements of one node of the P2P network according to an embodiment;

FIG. 3 shows a logical view of the centralized administration system (WebManager) for the P2P network;

FIG. 4 shows a logical view of a sender part of one node according to an embodiment;

FIG. 5 shows a logical view of a receiver part of one node according to an embodiment;

FIG. 6 shows a logical view of sender, receiver and administration system according to an embodiment;

FIG. 7 shows a formation of a receiver node of the P2P network, according to an embodiment;

FIG. 8 shows a formation of a sender node of the P2P network, according to an embodiment;

FIG. 9 shows a sending of telco records according to an embodiment; and,

FIG. 10 shows a verification of the telco record transport according to an embodiment.

### DETAILED DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

The embodiments described provide a timely delivery of roaming usage information, to a roamer's home network for the purposes of identifying fraud. The information can be different kinds of telco (telecommunications company) records, including CDRs such as FIGS compliant call data records described in more detail below, or IPDRs (12-15/Internet Protocol Data Records, a standard promoted by the well known IPDR organization, details are available from them), or LBS X&Y (Location Based Services X&Y co-ordinates) for example. Another alternative for the future is the prospective NRTRDE standard (Near Real Time Roaming Data Exchange) currently under development by the GSM association. The embodiments use the example of the existing market of GSM Association networks and particularly 2G voice. However, it is recognized that everything is applicable to other types of mobile networks, including satellite networks, or networks using handsets as mini base stations, for example. It is also applicable to inter-standard roaming and future 2.5G (GPRS) and 3G networks. It involves P2P based communications to convey roamer telco records between roaming partners. By employing the Internet as the carrier the need for expensive network infrastructure can be avoided and ubiquitous access is available, allowing the possibility for mobile network operators to use the service. Once established, telco record transfer is direct, between the sender and receiver, through a pipe, protected with encryption and involving no intermediate systems other than the Internet. Security of the transfer is important, so that the sender is confident they will be paid for the roaming usage, and so that the recipient, the home network, is confident that no false records are being received and therefore paid for.

A preliminary feature is to identify and collect telco records belonging to network visitors, before transfer to the appropriate roaming partner in a timely manner. There are various strategies for the selection of roamer telco records. The main application (ie. detection of roaming fraud) is largely dependent on the relevance and completeness of the data acquired. Care has to be taken to ensure that there are no errors in this process. An operational assumption is that the sending operator will be able to provide telco records selected by visiting roamers and that data presented to the telco record transport system will be sent. Dealing with or accommodating duplication is a responsibility of the receiving operator.

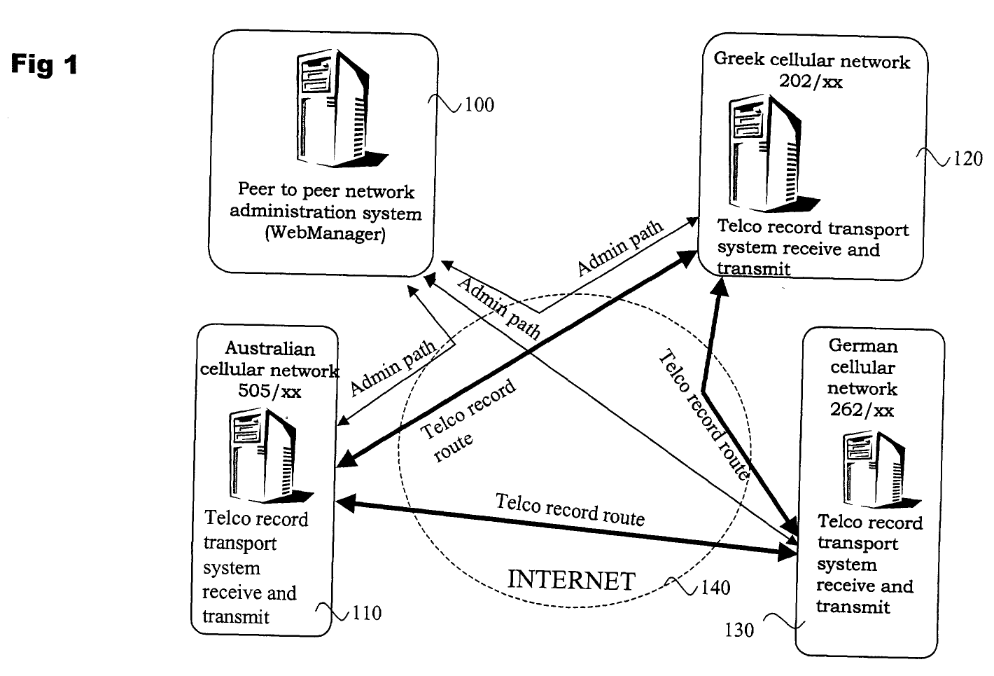

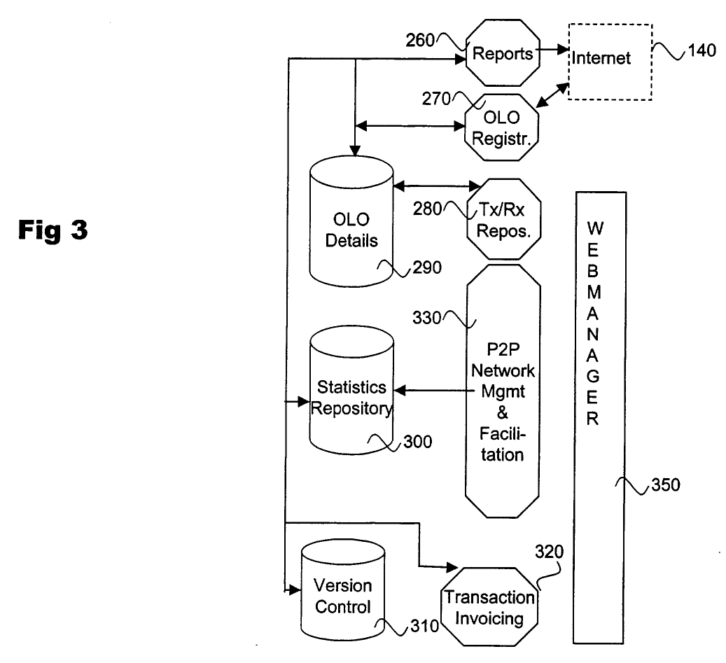

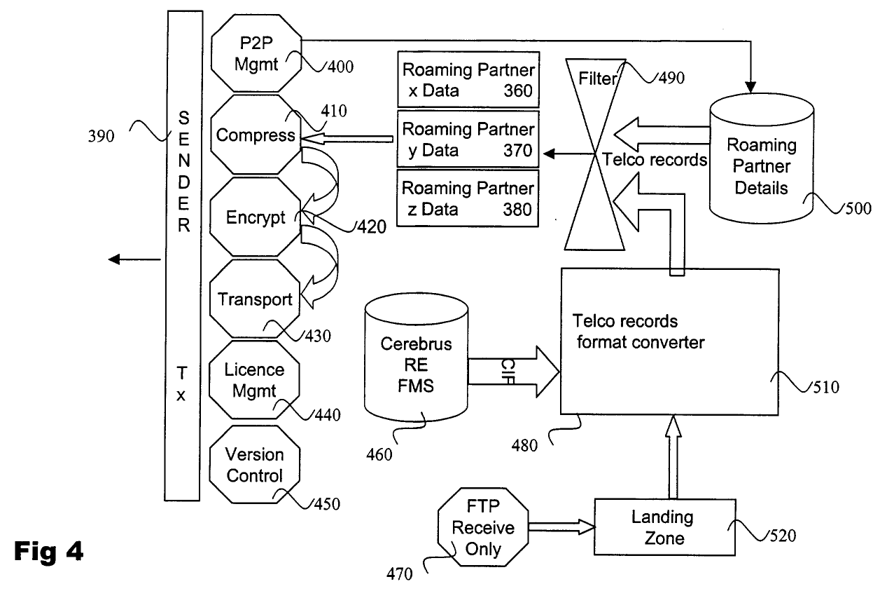

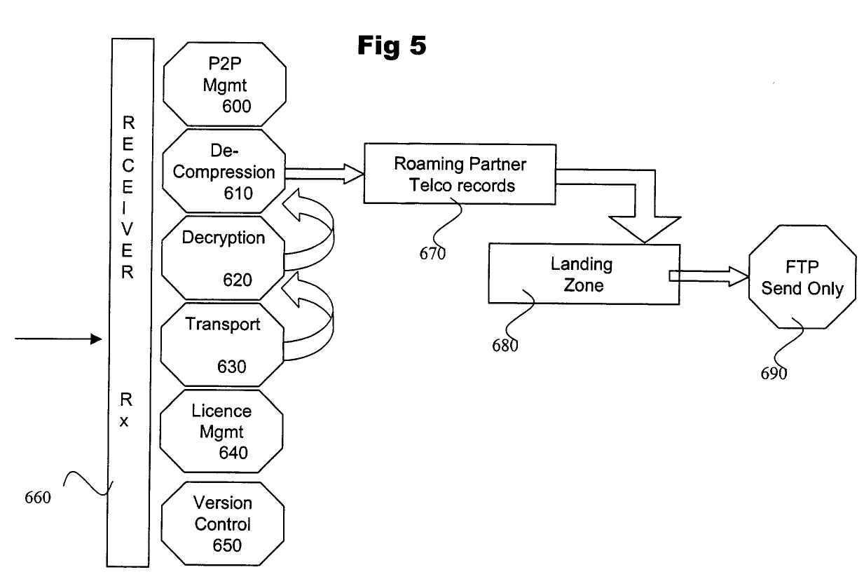

FIG. 1 shows an example in schematic form of a P2P network, for sending telco records between mobile networks directly, without using a central clearing house. Three mobile networks are shown, in practice there could be hundreds. An Australian network 110, a Greek network, 120, and a German network, 130 have a telco record transport system for sending and receiving the telco records. These transport systems route the telco records to whichever of the networks is the home network for each telco record, over the public internet 140. An example of how the sending and receiving parts of these systems can be implemented will be described below with reference to FIGS. 4 and 5. These systems and the routes over the public internet make up the P2P network. A centralized administrative feature 100 is also provided for the P2P network. This feature is coupled to the telco record transport systems of the mobile networks by admin paths running over the public internet. An example of how this feature can be implemented will be described below with reference to FIG. 3.

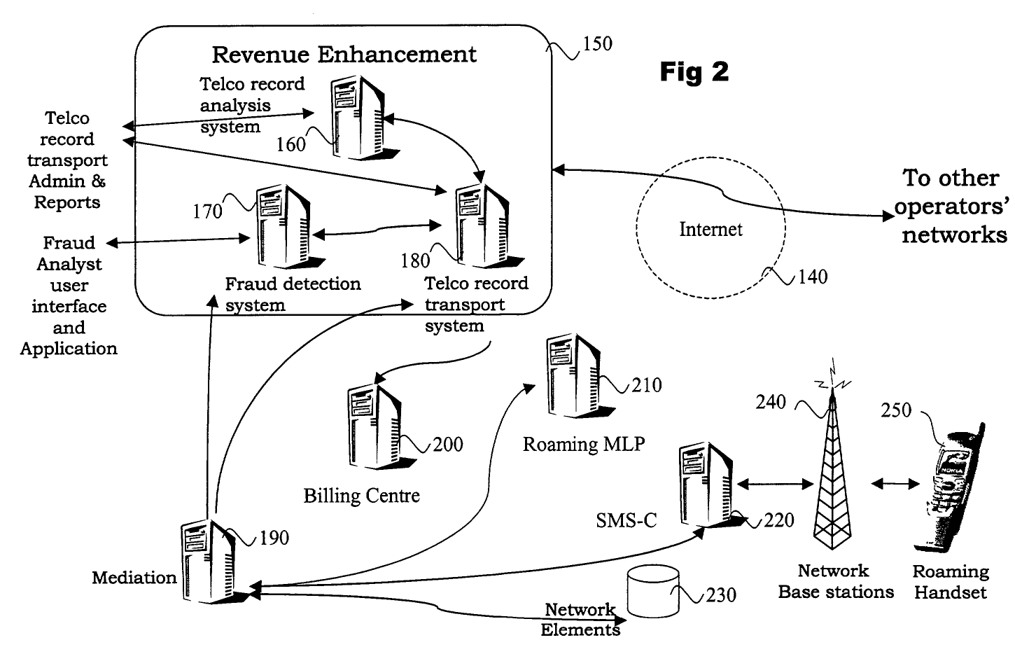

FIG. 2 shows an over view in schematic form of the principal elements at one node, in other words at one operator's mobile network. The network includes base stations 240, for communicating by radio with handsets 250. Details of calls are sent from many base stations by means of SMS (Short Message Service) messages to a central message server SMS-C, 220. This feeds a mediation server 190, which is coupled to a roaming MLP, 210 (GSM Master Location Platform) which provides which network-cell id a handset is communicating in). The mediation server is also coupled to network elements 230 (voice switch, handle, route the call and produce call detail record as statement of the call made). The parts described so far are conventional GSM elements, following the GSM standard, and so need not be described in more detail here.

Added to these, are the new revenue enhancement parts 150. These include the telco record transport system 180, coupled to the internet 140, a fraud detection system 170, and a telco record analysis system 160. The fraud detection system can be a conventional system as already marketed by Cerebrus Solutions Ltd and others, and so need not be described in more detail here. The telco record analysis system can be an alternative to a fraud detection system, if desired, to reduce costs, or it can complement the fraud detection system. It can provide reports such as IMSI High Usage By Time, IMSI High Usage By SDR, or SDR and Real Costs/Minute Per IMSI, for example, where IMSI is the International Mobile Station Identifier, which is a unique number allocated to a SIM card and so refers to the subscriber.

The fraud detection system can output to a user interface for manual intervention by human operators to limit fraud for example, or it can output to other applications. Another user interface can be provided for outputting the telco record analysis reports and for administrative input or output to or from the telco record transport system. An example of how the telco record transport system can be implemented will be described below.

FIG. 3 shows a logical overview of an example of the central administrator, or web manager, for the P2P network. One of its principal features is as a central address WebManager for management of roaming partner details. A feature to support the P2P (P2P) model is that the roaming partner management list feature should be delivered via an address WebManager. In this approach a roaming partner's own information is maintained by themselves on the WebManager, and they do not have to define or maintain other roaming partner's information manually. Also, the roaming partner data once entered (or updated) by the roaming partner, is transmitted to an internet based server (the WebManager) for sharing with the Receiving units. Preferably the roaming partner data is available to both the Receiver and Sender units of an operator so that a network operator can maintain details in one place.

The methods and systems do not include re-keying of roaming partner details and can ease management, administration and license control. The Sender unit will automatically determine, via the WebManager, who has a Receiver online and send their respective roaming telco records directly and without user intervention. For example, Telco A has a Sender and Receiver unit, their 200 roaming partners also have a Sender unit, when Telco A's Sender/Receiver unit registers itself with the WebManager, the 200 roaming partners Sender unit automatically discover that they can now filter-out Telco A's roaming telco records and send them directly. When Telco B is added to this model, the 200 roaming partners Sender unit repeat the discovery process and once again start sending the other roaming telco records to Telco B.

The WebManager can act as a repository for the roaming partner information, rather than as a clearing house for the actual roaming telco records. The telco records are conveyed on a P2P basis and are encrypted to maintain privacy. This, and the active introduction and supervision of activities by the WebManager can provide suitable integrity. The WebManager is central to the formation growth and maintenance of the P2P network, as well as its operation and security between the Senders and Receivers on an on-going basis. This involves validation of operator to operator transfers to prevent misuse and fraud.

The WebManager shown in FIG. 3 includes a store of roaming partner details, called OLO (other licenced operator) details, 290, a store of P2P network statistics, 300, and a version control store 310. Logical actions include issuing reports, 260, to operators, and handling OLO registrations 270, over the internet 140. The validation of telco record transmissions is represented by the Tx/Rx Repository 280. Other actions include P2P network management and facilitation 330, and transaction invoicing 320. Management of the various features is represented by manager 350.

FIG. 4 shows part of the telco record transport system. The roamers telco record information is received from the operators network by an FTP receive only feature 470, and fed to a “landing zone” 520 (an area assigned for the temporary storage of telco records that have been received from either down-stream or external system). Optionally a Cerebrus RE Fraud management system 460 can be provided, (acting as telco record repository, see above external system) feeding CIF data to a converter 510. The received data from the landing zone is converted from ASCII/binary into FIGS or CIF format for example, by convertor 510, for input to filter 490. Here they are combined with relevant roaming partner details stored at element 500. This is fed by a P2P network management feature 400. Examples of roaming partner data, X,Y and Z, (360, 370, 380) in FIGS or CIF format in this example, are combined with the telco records from convertor 510, in the filter 490. Next is a compression feature 410, then an encryption element 420. Transport feature 430 then sends the details over the internet. License management 440 and version control 450 features are also provided. Overall management of the various features is provided by sender Tx element 390.

FIG. 5 shows another part of the telco record transport system. It includes a receiver side P2P management feature 600, receiver side license management 640, and receiver side version control 650. Incoming data is handled by receiver side transport feature 630, followed by decryption 620, and de-compression 610. Resulting telco record data 670 in FIGS or CIF format is fed to the receiver side “landing zone” and sent on to other operator features by FTP send only 690. Overall management is represented by element 660.

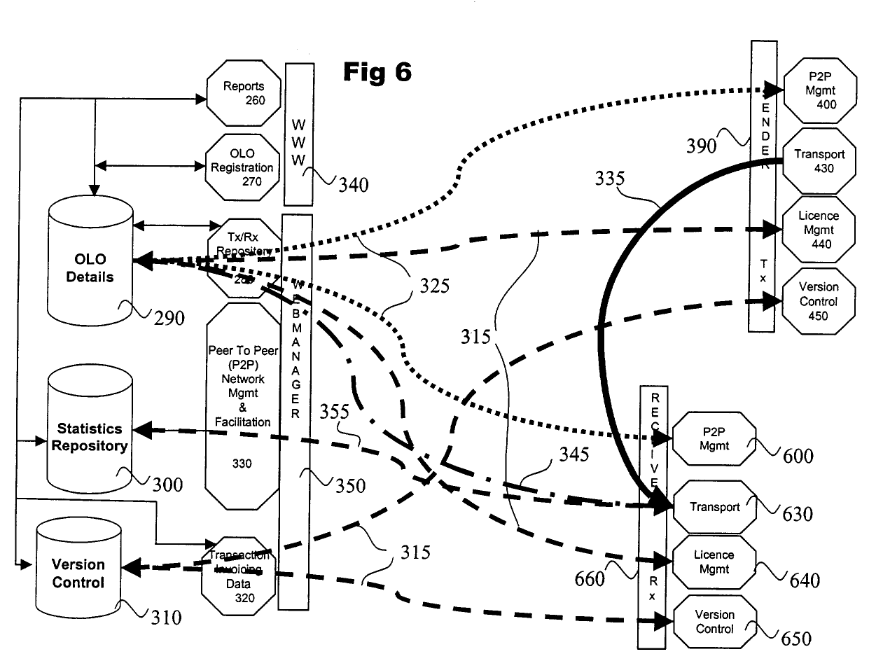

FIG. 6 shows parts of the sender, receiver and central administrative system of FIGS. 3, 4 and 5, and data and message flows between the various elements. Reference numerals correspond to those of the above mentioned figures where applicable. Interaction between version control elements, and between license management elements is shown by flows 315. P2P network management information flows are shown by paths 325. Telco record transport flows directly from sender to receiver are shown by part 335. When the receiver detects an incoming telco record file from a sender, it contacts the central administration system, to validate that the message is from a registered sender, shown by flow 345. Once validated, and passed on, the receiver can update the statistics held centrally, shown by flow 355.

### Telco Record Transfer Process—Introduction

Transfer usually requires the preparation of a batch of files containing telco records and their transfer to the appropriate receiving operator. They are retrieved from a known location where visiting roamer telco records have been placed. Files are prepared for transfer according to home network identifiers in the telco records and then sent to the home network. The transmissions are P2P and secure in order to ensure the integrity of the transferred data and also privacy. To achieve the integrity of the transmission the “Sender” is able to map roaming partners to delivery addresses. The “Receiver” is able to identify that the file has been received from a legitimate roaming partner and that its integrity has been maintained during transmission. As there is an existing international standard, the FIGS standard, it is preferable for the fields in transferred voice (2G) telco records to conform to this.

### Telco Record Transfer Process—Collection and Filtering Process

In this preliminary part of the transfer process the operator collects billable telco records involving calls made by visiting roamers. In order to provide a simple, easily installable solution where the stand-alone “sender” application is deployed, it is preferable that identified telco records, regardless of duplication etc, be forwarded. Bearing in mind many frauds exploit system misconfigurations and process weaknesses, it is considered preferable for the home network to receive indications of activity for fraud management purposes.

### Telco Record Transfer Process—Data Extraction

In this feature the operator extracts roamer telco records from the visited network and to transfer them to the correct roaming partner. A list of roaming partners is provided such that the telco records generated by subscribers belonging to a roaming partner can be identified, extracted and collated into a telco record file specifically for that partner. The list enables the telco record file to be encrypted and transferred to the appropriate electronic address for the roaming partner. Telco records for network visitors are selected and sent to their home network, provided that the home network is registered to receive the data, otherwise it may be discarded. Should a target receiver not be on line, the sender does not send the files to that receiver but retains them for a period of up to 5 days. Should the receiver come back on line in that time, then the files can be sent. Once the file store becomes full the sender may reuse the space, overwriting the oldest data first.

Telco records are collected from a known location via FTP (file transfer protocol). The Operator pre-selects the telco records for visiting roamers. The sender then separates them by network operator. Incoming telco record formats are mapped to the Exchange File Transfer Format (see below) using an easy to use, customer configurable tool. This enables character format files to be mapped, and enables binary telco record files to be translated and mapped (Note: Ericsson is currently the mobile network market leader and they primarily use ASN01 encoded call data, so it is useful to be able to convert such data).

### Telco Record Transfer Process—Selection By Roaming Partner

Telco records are selected by using an identifier. An example is the home network identifier shown by the Mobile Country Code and Mobile Network Code parts of the GSM IMSI (International Mobile Subscriber Identifier). The identity of the home network is encoded within the subscriber's identity which is represented by the IMSI which is a maximum of 15 characters long. IMSI is composed of three parts:

a. Mobile Country Code (MCC) consisting of three digits. The MCC identifies uniquely the country of domicile of the mobile subscriber;

b. Mobile Network Code (MNC) consisting of two or three digits for GSM applications. The MNC identifies the home GSM PLMN of the mobile subscriber. The length of the MNC (two or three digits) depends on the value of the MCC. A mixture of two and three digit MNC codes within a single MCC area is not recommended and is outside the scope of this specification.

c. Mobile Subscriber Identification Number (MSIN) identifying the mobile subscriber within a GSM PLMN. (Note The National Mobile Subscriber Identity (NMSI) consists of the MNC and the MSIN.)

Other types of home network identifier which can be used as alternatives to the IMSI include the IMEI, International Mobile Equipment Identifier, which is a unique number allocated to a handset rather than a SIM card. For other types of networks, dealer codes, MINs, ESNs or similar can be used.

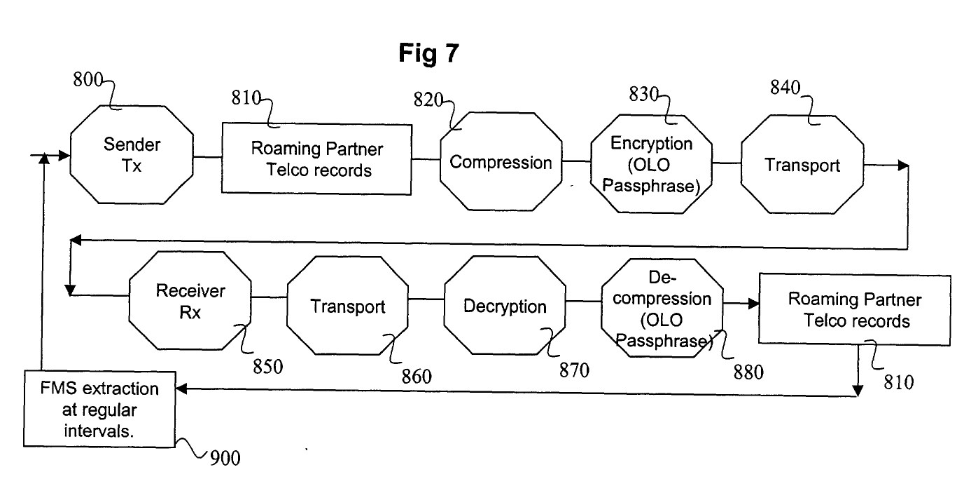

FIG. 7 shows the process in schematic form. At 800 the sender Tx starts the process by fetching the roaming partner telco record data 810, which is then compressed 820. This is followed by encryption 830 including the OLO credentials, such as a pass phrase. The encryption can involve well known public key encryption methods, or traditional secret-key encryption, and can encrypt or decrypt memory buffers, strings, blobs, streaming data or files. For traditional strong encryption, the new AES (US Advanced Encryption Standard) symmetric encryption method known as Rijndael can be used. Another alternative is Twofish, the runner-up candidate for AES. The transport 840 is then carried out over the internet, to the relevant operator. This involves for example a point to point tunnel to provide a seamless connection following established principles. A tunnel is a term used in TCP/IP networks to refer to a connection between two local non connected LANs by enscapsulating local TCP/IP packets and routing them over the public internet, or optionally over a private dial up connection. At the receiver side, the receiver Rx 850 handles the receiver side transport feature 860, followed by decryption 870 and decompression 880, to extract the OLO credentials such as pass phrase, to enable verification, and extract the roaming partner telco record data 810. The received telco record data is passed to the FMS at 900, for example in batches every few minutes, or in a near real time stream, if the FMS can accept it. The transfers from the sender can be repeated regularly, at intervals of seconds or minutes as desired, for near real time response.

### Roaming Partner List

It is possible for individual operators to create and maintain their entries in the list of roaming partners held by the WebManager. The entries include:

a. Name, i.e., Company Inc.

b. Network Type (GSM 2G, GPRS 2.5G or UMTS 3G etc)

c. Home Network Identifier i.e., 32299 (for example in GSM Voice telco records would be the IMSI components MCC and MNC, but may also be other network identifiers as previously stated)

d. Contact, i.e., Fred Smith

e. Contact Email, i.e., fred.smith@company.com

f. Contact Telephone, i.e., +44 700 397 0105 (international format)

g. Fax, i.e., +44 700 397 0105 (international format)

h. Address, e.g Great Eastern House, Edinburgh Way, Harlow, Essex, CM20 2NQ

i. Country, i.e., United Kingdom (UK)

j. Passphrase (min. 14 length, 2 numbers etc)

k. Emergency Contact Email, i.e., support@company.com

Additionally the WebManager allows the maintenance of the following P2P network administrator's control fields in the roaming partner list. They are visible to 1 5 the customer to whom they belong.

a. Licence Type (Trial [1 month auto expire], Permanent)

b. Licence Start Date & Time

c. Licence End Date & Time (for permanent set to 1 year from start date for subscription renewals)

The details in the roaming partner list are used in forming the P2P network by “Introducing” senders and receivers, by downloading the details to the senders and receivers, and by validating senders and receivers to assure valid transfers.

### Transferred Telco Record File Content

An example of telco records in the form of a CDR file comprises FIGS. fields (see below) and eight additional fields reserved for future use by Cerebrus Solutions Ltd or a future P2P network administrator. One of these fields is reserved for the alternative CDR selection mechanism. The CDR file content is that defined for FIGS, i.e Annex A of Digital cellular telecommunications system (Phase 2+); Fraud Information Gathering System (FIGS); Service description—Stage 1 (GSM 02.31 version 7.1.0 Release 1998), to which the reader is referred.

The reports generated by the Visited Public Land Mobile Network (VPLMN) are in the form of “call information” records for monitored subscribers. The content of the call information will depend on the type of event (call start, end etc.). To simplify matters, there will be one format for both Mobile Originating (MO) and Mobile Terminating (MT) calls with an MO/MT indicator within the call information to distinguish between the two. A partial call information will be sent to the Home Public Land Mobile Network (HPLMN) when there is an mid-call invocation of a supplementary service and when a call in progress has exceeded a defined duration.

Some explanation of the content and usefulness of the fields of a CDR now follows.

The Dialed digits are an important indicator in deciding if a call is fraudulent or not—certain call destinations are more likely to be called fraudulently than others.

The “A” subscriber can be used to identify the subscriber

The “B”, and “C” subscribers are relevant as some call destinations are more subject to fraud than others.

The Cell Global Identifier (CGI) is relevant as some cells in a PLMN are more subject to fraud than others.

The IMSI is used to reference the subscriber.

The IMEI can be used to check if a stolen handset has been used.

The Call Start Time/Date allows the call duration to be calculated (if the call end time and not call duration is given at call conclusion) and because the call start time can also be an important indicator of fraudulency.

The Call Duration gives the duration of the call at the sending of the partial call information—call duration can be an important indicator of fraudulency. If call end is sent instead, the duration can be calculated using the call start and end times. The Call Reference is used to reference a particular call.

The MO/MT indicator indicates whether call charging is according to MO or MT calls.

The Visited MSC address gives the PLMN on which the call was made.

The Type of SS event record is sent if the “call” start is actually the invocation of a supplementary service, e.g. ECT. The Type of SS event can help to indicate if the mobile is being fraudulently used or not.

The Type of Basic Service indicates whether a teleservice or bearer service is being used and which sort of teleservice or bearer service is being used and is sent if the event is a call and not a supplementary service. The Type of Basic Service can help to indicate if the mobile station is being fraudulently used or not.

Where data is not available for a field it is sent as a blank field.

### File Encoding

The information content of the CDR transfer file is described above is usually encoded in an ASCII Separated Variable format, and is compressed to reduce bandwidth requirements. To ensure integrity of individual files and the sequence of files, the following measures are taken, others are conceivable:

1. The file is protected with a checksum mechanism allowing simple corruptions to be detected and corrected.

2. The files are date and time stamped to indicate the time they were closed.

3. The files for a roaming partner have a sequential serial number in order to identify that files have gone missing. If needed this may be cyclical over a large number such that the combination of date and number provide a sufficiently clear identifying mark. Generation of the serial number is carried out in the WebManager.

### File Transfer, Delays and Testing

A configurable period between file transfers to a Roaming partner is provided, typically set at 30 minutes. A suitable file size is pre-determined and if the file is filled sooner than 30 minutes it is transmitted when it is full. Where this is no data available at the set period, then an empty file is sent to confirm operation. The transmission delay for telco record files should be minimised. “Connections” between roaming partners are preferably tested regularly to ensure that the correct connections are made and remain functional.

File Transfer to the roaming partner is guaranteed. The file exchange mechanisms are preferably proprietary in order to facilitate commercial control via licensing (not to be confused with the open transport protocol such as the use of TCP/IP and P2P strategy, to ensure data is securely moved from location to location guaranteeing file integrity, non-repudiation and exclusion of a party outside of the closed group of roaming partners). Files of telco records are transferred between the sending and the receiving systems by P2P interaction. The sender stores telco records for a period to allow for failure to receive by the roaming partner for outbound telco records. Likewise the receiver stores inbound telco records until the fraud management system (FMS) has accepted them. Automatic or manual recovery is provided to initiate the re-transfer of un-received telco records. The WebManager monitors activity and if a sender or receiver is off-line for a configurable period, default 60 minutes, an alert such as an email is sent to affected customer notifying them of the condition.

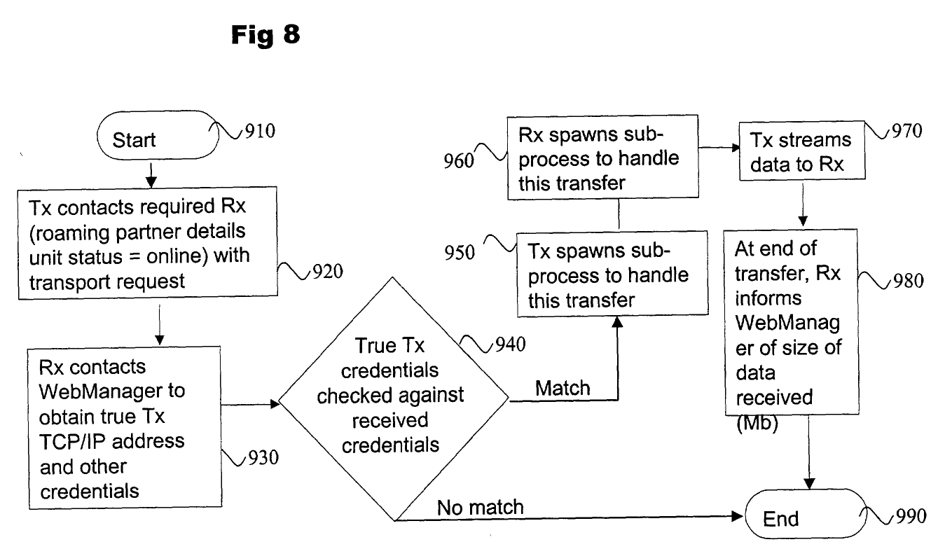

The receiving system checks that the file is from a member of the closed roaming partner community, and that the file is from the claimed sending party. At this time, the file is presented to the receiving FMS for fraud processing. The system alerts the operator should the above checks indicate that the integrity of the file cannot be trusted. As shown in FIG. 8, after the process starts 910, the Tx contacts the specified Rx with a transport request 920. The Rx contacts the WebManager to obtain true TCP/IP address and other credentials such as encryption passphases and network codes 930. These are checked 940 against the received credentials, either at the WebManager, or the Rx. If there is no match, the process ends at 990, and there can be appropriate alerting actions. If there is a match 950, the Tx spawns a sub-process to handle the transfer. Likewise at 960, the Rx spawns a subprocess to carry out the transfer. 970 shows the transfer, and at 980, after the transfer, the Rx informs the WebManager of the amount of data received.

### User Interface

The user interface for the Sender and Receiver is PC Windows hosted for convenience to enable services including cut and paste facilities, allowing integration with other applications.

### Operational Environment

A solution hardware platform for the customer-resident parts includes PC based servers, although non PC-based servers can be used. The WebManager, where it is a Cerebrus Solutions Ltd operated solution, can employ a suitable environment, though one Operating System is Windows 2000, and those of ordinary skill will recognize that other operating systems can be used. A user interface environment is Windows native (2000 or XP), although other environments may also be used. The stand alone Sender and Receiver Applications can be hosted in a UNIX environment if volume and throughput considerations demand. This can enable lower cost deployment. The application is capable of full integration with other Windows applications. It should be possible to configure the system by the importation of files rather than only via configuration tools. The bandwidth of the network connection to support effective operation of the solution is typically in the region of 2.048Mb/s.

As the WebManager is key to the reliable delivery of the service, WebManager resilience is an issue. Preferably it is tolerant to faults so as to prevent P2P network outages (0-hour outage tolerance) and tolerant to faults so as to reduce service down time for the Web based reporting and registration services (8-hour outage tolerance).

### Throughput and Scalability

The GSM Association reported in May 2000 that Roamer call volumes for December 1999 reached 530 million per month and that in November 2000 that Roamer call volumes had reached 750 million per month. The busiest operators are estimated to have in the region of 300,000 roaming calls per day. The busiest 30 minute period is expected to include about 15% of that figure, which comes to 45,000 calls. Assuming 256 bytes for a telco record, the sender for that operator needs to be able to send out in the order of tens of Mbytes at least, which following coding and compression, is in the order of several Mbytes at least. The WebManager has capacity for carrying out the validation for telco record transfers from 400 or so GSM operators, every 30 minutes, i.e. up to 400 times 400=160,000 validation operations.

### Other Central Administration Features

The central WebManager can optionally be used for other admin features. The WebManager is preferably arranged to facilitate automatic software maintenance of a deployed remote solution without customer intervention. It also optionally enables independent reporting. Reporting can provide the ability to audit the amount of data transferred and the destination of the files. It also allows more general reporting as discussed below. Because of the supervisory role of the WebManager, data is available and the reporting becomes available as another WebManager based service which adds value. For example it can record network statistics including details of operator to operator transfer over a rolling 13 month window, and provide a Web based service to allow operators to remotely run reports on their own network activities and transfers.

Management reports can be useful to guarantee a proper audit of the process by giving a picture of the file transfer process. WebManagerAny files containing partner details, licence details, licence metrics and audit logs are secured from unauthorised manipulation. They are intended to permit audit of file transfer parameters such as: accuracy, completeness, timeliness, fraud, effectiveness, efficiency, integrity, compliance, continuity, licence enforcement and billing.

A report set at the sender end pertaining to file transmission can include a log of file transfer exceptions and a log of files sent to a roaming partner. A minimum set of reports available from the WebManager can include a log of registered transfers including date, time, volume and transmission sequence number.

The WebManager can also facilitate customer registration, software down load and software licence key generation and distribution.

The WebManager is a key component in customer and licence management, thus it:

1. Provides a Web based service to allow operators to register and subsequently maintain their particulars for the service.

2. Enables electronic delivery of the solution to the operator.

3. Provides license control mechanisms to ensure end users of the solution (operators) are known, and only able to use the system if licenses have been issued and have not been revoked.

4. Provides a mechanism to ensure operators details or subsets of operators details kept secure.

5. Provides a data feed of network statistics for up-stream invoicing purposes on an automatic basis.

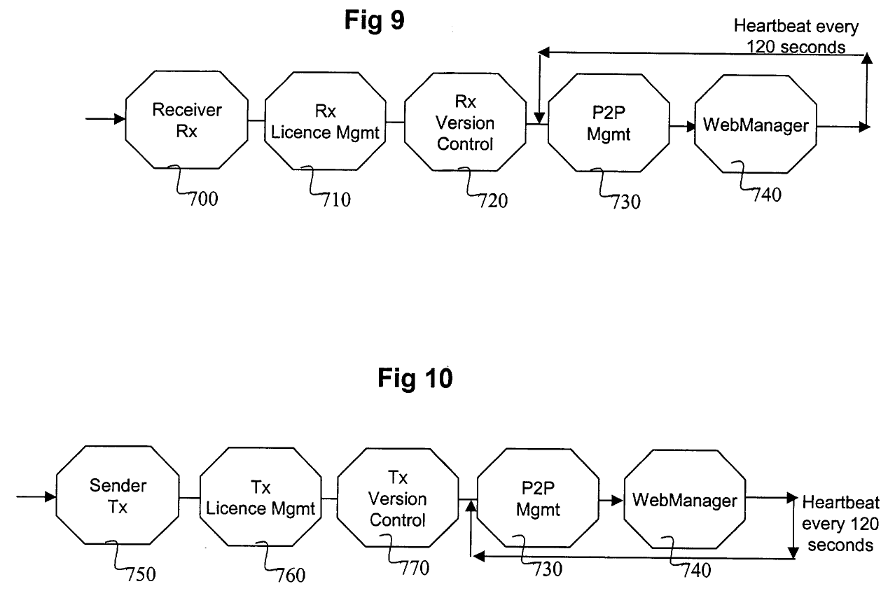

FIG. 9 shows the addition of a receiver Rx to the P2P network. It starts with a receiver Rx contacting the WebManager 700 to start the registration. At 710, license management features are carried out if appropriate, to check the receiving operator has paid for the service. At 720, version control features are carried out, to ensure the Rx software is up to date, or at least make the WebManager aware of the version and therefore capabilities of the Rx. Once those registration preliminaries are completed, the Rx then becomes part of the P2P network and takes part in P2P network management activities at 730. At 740, the WebManager carries out a heartbeat check of the Rx.

FIG. 10 shows an addition of a transmitter Tx to the P2P network. It starts with a transmitter Tx contacting the WebManager 750 to start the registration. At 760, license management features are carried out if appropriate, to check the operator has paid for the transmission service. At 770, version control features are carried out, to ensure the Tx software is up to date, or at least make the WebManager aware of the version and therefore capabilities of the Tx. Once those registration preliminaries are completed, the Tx then becomes part of the P2P network and takes part in P2P network management activities at 730. At 740, the WebManager carries out a heartbeat check of the Tx.

As has been described above, a system for a visited mobile telecommunications network, for sending information relating to roaming use back to a home network of the roaming user, sends telco records in near real time over a direct, P2P route, over the internet, not via a central clearing house. By sending the information more quickly, fraud detection at the home network can be improved. As this decentralized arrangement involves lower costs to the visited network, it is more likely to be installed by operators in higher risk areas, so benefits of wider coverage (“critical mass”) can be achieved. A central WebManager manages the P2P network and maintains a record of operators to verify the information sent between nodes of the P2P network, is from a recorded operator.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. References to devices that include a processor, as provided herein, can be further understood to be references to “a processor.” Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet.

Other variations will be apparent to those skilled in the art, having corresponding advantages to those set out above, within the scope of the claims.

1. A system for a first mobile telecommunications network, for sending information relating to use of the first network by a roaming user from one of many other mobile telecommunications networks, the system including at least one processor having instructions to:
identify which of the other networks is a home network of the roaming user, and send the information to an operator of the home network, in near real time over a direct peer-to-peer (P2P) route.

2. The system of claim 1, having instructions to route the information over the public internet.

3. The system of claim 2, having instructions to route the information in a secure, encrypted form.

4. The system of claim 3, having instructions to receive information from other operators, relating to roaming by a user whose home network is the first network, the information being routed over a direct P2P route.

5. The system of claim 4, having instructions to cooperate with a central manager for verifying the validity of a sender of the information received, the central manager having a record of operators who have agreed to be roaming partners.

6. The system of claim 5, having instructions to allow operators to remotely update the record of operators who have agreed to be roaming partners.

7. The system of claim 4, having instructions to provide the received information to a fraud detection system.

8. The system of claim 7, the received information comprising one or more call detail records.

9. A system for a first mobile telecommunications network, for sending information relating to use of the first network by a roaming user from one of many other mobile telecommunications networks, the system including one or more processors having instructions to:
identify which of the other networks is a home network of the roaming user, and
send the information to an operator of the home network, in near real time over the public internet.

10. The system of claim 9, having instructions to route the information in a secure, encrypted form in a point-to-point manner.

11. The system of claim 9, having instructions to receive information from other operators, relating to roaming by a user whose home network is the first network, the information being routed over the public internet.

12. The system of claim 11, further having instructions to use the received information for fraud detection.

13. A method of detecting roaming fraud for use by an operator of a first mobile telecommunications network, when subscribers of the first network conduct roaming usage of one of many other mobile telecommunications networks, the method comprising:
receiving information from another of the operators, relating to the roaming usage, the information being routed over a direct P2P route, and,
using the received information to detect fraudulent usage.

14. A method of roaming usage by a subscriber of a first mobile telecommunications network, the network having a fraud detection system, the method comprising:
conducting roaming usage when visiting one of many other telecommunications networks,
causing the visited network to send information relating to the roaming usage, to the first network, for use by the fraud detection system, the information being routed over a direct, P2P route, and
receiving a bill from the operator of the first network which has been checked for fraudulent usage, and including an amount for the roaming usage.

16. A central manager for use with a P2P network used for sending information relating to roaming usage between network operators, the manager having:
a record of operators who are in the P2P network, and
an arrangement for communicating with nodes of the network, to verify the information sent between nodes of the P2P network, is from a recorded operator, using the record.

17. The central manager of claim 16, additionally being arranged to provide central management of the P2P network.

18. A method of offering a central validation service for a P2P network used for sending information relating to roaming usage between network operators, the method comprising:
maintaining a record of operators who are in the P2P network, and
communicating with nodes of the network, to verify information sent between nodes of the P2P network, using the record.

19. A method of offering a data transmission service over a network having the system of claim 1.
